(19) United States
(12) Patent Application Publication
(10) Pub. No.: US 2016/0303940 A1
(43) Pub. Date: Oct. 20, 2016

(54) FLANGE ASSEMBLY, CHASSIS ACTUATOR AND METHOD FOR PRODUCING THE FLANGE ARRANGMENT

(71) Applicant: SCHAEFFLER TECHNOLOGIES AG & CO. KG, Herzogenaurach (DE)

(72) Inventors: Hartmut Krehmer, Erlangen (DE); Thomas Dirnberger, Obermichelbach (DE); Rudolf Faber, Langensendelbach (DE); Alois Friedrich, Dinkelsbuhl (DE); Manfred Gotz, Memmelsdorf (DE); Harald Hochmuth, Hagenbuchach (DE); Thomas Kraemer, Roethenbach (DE); Carsten Liebert, Herzogenaurach (DE); Ralf Mayer, Herzogenaurach (DE); Marco Meisborn, Hochstadt a.d. Aisch (DE); Bernd Winkelmann, Herzogenaurach (DE)

(73) Assignee: SCHAEFFLER TECHNOLOGIES AG & CO. KG, Herzogenaurach (DE)

(21) Appl. No.: 14/782,447

(22) PCT Filed: Mar. 28, 2014
(86) PCT No.: PCT/DE2014/200145

§ 371 Date: Oct. 5, 2015

(30) Foreign Application Priority Data
Apr. 4, 2013 (DE) 10 2013 205 904.3

(51) Int. Cl. B60G 21/055

(52) U.S. Cl. CPC B60G 21/0555; B60G 2206/427; B60G 2206/82; B60G 2206/8206; B60G 2206/8207; B60G 2206/91; F16D 1/076

(57) ABSTRACT

The invention relates to a flange assembly which takes up little installation space yet is nevertheless able to transfer high torques. According to the invention the flange assembly (5) includes a flange section (11) and a receiving section (6), wherein the flange section (11) is connected to the receiving section (6), to a holding body (10) and to a coupling body (7), wherein the holding body (10) is connected to the receiving section (6), wherein the holding body (10) is arranged in the axial direction between the coupling body (7) and the flange section (11), wherein the coupling body (7) is supported in the axial direction on the holding body (10), wherein the coupling body (7) and the flange section (11) are connected to one another in the axial direction and wherein the flange section (11) is connected to the receiving section (6) by virtue of the coupling body (7) being supported on the holding body (10).

### BACKGROUND

The invention relates to a flange assembly with a flange section and a receiving section, wherein the flange section is connected to the receiving section. The invention further relates to a chassis actuator and to a method for producing the flange assembly.

In principle, flange connections are used for connecting two components. Another task of flange connections is also to transfer operating forces according to the application. For example, flange connections are used in stabilizers in motor vehicles in order to implement a connection and a torque transfer between individual components.

The publication DE 10 2010 044 799 A1 that represents the closest prior art describes a stabilizer with a stabilizer profile and a flange. The stabilizer profile is arranged overlapping the flange in some areas. The flange and the stabilizer profile are connected to each other via a fillet weld.

### SUMMARY

The invention is based on the objective of providing a flange assembly that is simple to produce, requires little installation space, and can nevertheless transfer high torques. The invention is also based on the objective of providing a chassis actuator with such a flange assembly and also a method of production.

These objectives are achieved by a flange assembly, a chassis actuator, and by a method with one or more features of the invention. Preferred or advantageous embodiments of the invention are given from the dependent claims, the following description, and the accompanying figures.

According to the invention, a flange assembly is provided that can be integrated into any device for the most general instantiation of the invention. A preferred application, however, relates to the integration of the flange assembly in a chassis actuator, in particular, in a roll stabilizer.

The flange assembly comprises a flange section. Advantageously, the flange section is formed as a rotationally symmetric body. Preferably, the flange section has an annular flange that is formed, in particular, as a ring section. Optionally, the flange section also comprises a coaxial tube section. For example, the annular flange and the tube section have a T-shaped cross section cut in the axial direction. In particular, the annular flange is set on the outside on the tube section. For example, the tube section is connected integrally or with a material fit to the annular flange. Advantageously, the flange section is fixed with a component, e.g., integrally or with a material fit. Preferably, the tube section is a sub-section of the component. Alternatively, the component can be arranged on the tube section. For example, the component is a stabilization part of the chassis actuator, in particular, the roll stabilizer in a motor vehicle.

For modified embodiments, the flange and the tube section are arranged concentric to each other. For alternative embodiments or improvements, the flange and/or the tube section is or are non-rotationally symmetric, but have, e.g., an oval or irregular cross section.

The flange assembly comprises a receiving section. The receiving section can be formed as a sleeve-shaped housing section, in particular, as a rotationally symmetric hollow body. For example, the receiving section is an actuator connection part of the chassis actuator or a sub-area of the actuator connection part of the chassis actuator.

The flange section is connected to the receiving section so that the part that can be connected or is connected to the flange section, in particular, the stabilization part, can be attached or is attached to the receiving section. Advantageously, the flange section runs coaxial to the receiving section.

In the scope of the invention it is provided that the flange assembly comprises a holding body and a coupling body. The holding body is connected to the receiving section. Furthermore, the holding body is arranged in the axial direction between the coupling body and the flange section. The coupling body is supported in the axial direction on the holding body. In particular, the coupling body is fixed on the holding body by the support so that it cannot move in one of the two axial directions. Advantageously, the coupling body is supported directly on the holding body, so that the coupling body and the holding body are in contact.

It is further provided that the coupling body and the flange section are connected to each other, in particular, in the axial direction. In particular, the flange section and the coupling body are clamped to each other by means of the connection and by the support of the coupling body on the holding body. The flange section is connected to the receiving section by the support of the coupling body on the holding body. The axial direction runs parallel to or in the same direction as the assembly direction of the coupling body and/or the holding body.

The flange assembly according to the invention allows a secure connection of the flange section to the receiving section that can be implemented by means of a few assembly steps due to the structural design. The component that can be arranged or is arranged on the flange section is a rotating or oscillating component, for example, around the stabilization part, so torque can also be reliably transferred from the flange section to the receiving section.

In one especially preferred embodiment, the receiving section, the coupling body, the holding body, and/or the flange section or the flange are arranged coaxial to each other and to the axial direction.

It is possible that the coupling body and/or the holding body are arranged outside of the receiving section, in particular, on an outer lateral surface of the receiving section. However, it is especially preferred that the coupling body and/or the holding body are arranged within the receiving section, in particular, on an inner lateral surface of the receiving section. This arrangement saves installation space in the radial and/or axial direction in comparison to the arrangement outside of the receiving section.

For the support of the coupling body on the holding body in the axial direction it is preferred that the holding body and the coupling body form an overlapping area in the radial direction in an axial projection. Through the overlapping area and by means of the connection of the holding body with the receiving section, an unmovable, axial stop is formed for the coupling body. Advantageously, the holding body extends radially inward for forming the overlapping area starting from the receiving section.

Of the structural setup it is preferred that the coupling body is formed as a rotationally symmetric body. For example, the coupling body is a coupling washer, but in an especially preferred way, a coupling ring. In particular, the holding body has a circular, semicircular, or oval-shaped cross section cut in the axial direction as the coupling ring. Alternatively, a square or rectangular cross section cut in the axial direction is also possible.

It is preferred that the coupling body is held, in particular, with a positive fit, by the receiving section in the radial direction. Advantageously, an outer lateral surface of the coupling body and the inner lateral surface of the holding section form a radial positive fit. Through the positive fit hold in the radial direction, tilting of the coupling body in the receiving section is prevented and thus simple assembly of the coupling body in the receiving section is realized.

For connecting the holding body to the receiving section, the holding body is advantageously structurally designed so that it is held with a positive fit and/or force fit by the receiving section. For example, the holding body is connected in the axial direction with a force fit to the receiving section. For example, the holding body and the receiving section for the force fit connection have an over-dimensioned fit, wherein the holding body is stretched by means of cooling and/or the receiving section is contracted on the holding body by means of heating.

In an especially preferred way, the holding body is held in a positive fit in the receiving section with respect to the axial direction, so that this is supported in the direction of the flange section in the axial direction with a positive fit on the receiving section. This construction has the advantage that the flange assembly can be implemented without a material fit connection, wherein a completely detachable connection is produced.

In one especially preferred embodiment, the receiving section has an annular groove, in particular, an inner annular groove in which the holding body is arranged in a self-retaining manner. Advantageously, the holding body is connected to the annular groove with a positive fit in the radial and/or axial direction. For example, the annular groove has a circular, semicircular, oval-shaped, square, or rectangular cross section in the axial direction. In particular, the receiving section comprises a snap-on edge formed by the annular groove, in particular, a snap-on edge section that has a smaller diameter than the annular groove. The snap-on edge is arranged before the annular groove in the insertion direction of the holding body, so that the snap-on edge first must be overcome by the holding body in order to be arranged in the annular groove. One advantage of the annular groove is the assembly-friendly and precise positioning of the holding body on the receiving section. In addition, the annular groove permits reliable holding of the holding body without additional mechanical connecting means, such as rivet connections, or a material fit connection, such as a weld connection. This results in, on one hand, lower production complexity and costs and also, in particular, a detachable connection of the holding body with the receiving section.

For example, the holding body is formed as a ring, in particular, expansion ring, with radial slots. The holding body is formed so that it is elastic in the radial direction, in particular, as the radially slotted ring, so that the free ends move toward each other for overcoming the snap-on edge and move away from each other again in the annular groove, wherein the radially slotted ring advantageously assumes a positive fit connection in the radial and/or axial direction with the annular groove. Alternatively, the holding body is formed as a completely closed retaining ring in the circumferential direction. Alternatively, the holding body is cooled for overcoming the snap-on edge and/or the receiving section is heated, wherein the holding body is held at a normal or operating temperature of the holding body and receiving section advantageously with a positive fit with the annular groove in the radial and/or axial direction.

Preferably, the coupling body and/or the flange section exert a force on the holding body in the direction of the annular groove in the connected position due to their connection with each other, in particular, due to the clamping. Advantageously, the coupling body and/or the flange section contact the holding body such that the swaging force acts on the holding body and this is pressed into the annular groove. The force acting on the holding body in the direction of the annular groove prevents the risk that the holding body will come out from the annular groove, in particular, will be pressed out, due to the swaging by the coupling body. Alternatively, in the connected position, the coupling body and/or the flange section form a retaining contour that is arranged and/or formed for preventing the holding ring from coming out from the positive fit.

In one preferred structural improvement, the holding body has a D-shaped cross section in the axial direction, wherein a radially inner lateral surface of the holding body has a convex curvature. In particular, the coupling body and/or the flange section press on the radially inner lateral surface of the holding body in the connected position due to the clamping, wherein, due to the convex construction, the force acting on the holding body in the direction of the annular groove is designed so that the holding body is reliably held in the annular groove. Alternatively, the radially inner lateral surface is secured by the retaining contour.

Alternatively, the radially inner lateral surface of the holding body has a wedge-shaped construction at least in one of the two axial directions, so that the radially inner lateral surface is directed toward the coupling body or toward the flange section. In particular, the coupling body or the flange section that is directed toward the radially inner directed lateral surface presses onto the radially inner lateral surface of the holding body due to the swaging force or secures this surface due to the retaining contour. Due to the wedge-shaped construction of the radially inner lateral surface, the force acting on the holding body in the direction of the annular groove is designed so that the holding body is held reliably in the annular groove. Other alternatives for forming the radially inner lateral surface are constructions that prevent a force acting on the holding body only in the axial direction and thus prevent the holding body from coming out from the annular groove.

In one structurally simple and nevertheless functionally effective construction, the holding ring has a circular cross section, wherein the inner lateral surface of the holding ring is supported on the coupling ring and/or on the flange section or is secured by means of a corresponding retaining contour. In particular, the holding body is realized as a round wire ring.

In an especially preferred way, the flange section is supported in the axial direction on the receiving section. The support of the flange section on the receiving section is implemented, in particular, by the connection between the flange section and the coupling body. Advantageously, the flange section is supported directly on the receiving section, that is, facing axial contact end faces of the flange section and the receiving section contact each other at least in some sections. It is further preferred that the flange section is arranged at a distance and thus without contact relative to the coupling body. The distance to the coupling body guarantees for the connection, in particular, for the clamping or swaging of the coupling body and the flange section, a planar and/or non-positive fit arrangement of the flange section on the receiving section in the axial direction. Through the connection, a friction-fit connection between the flange section and the receiving section can be implemented.

Alternatively or additionally, the flange section is supported in the axial direction on the holding body, in particular, on the end side of the holding body facing away from the coupling ring.

The connection between the flange section and the coupling body for supporting the flange section on the receiving section and the coupling body on the holding body is advantageously constructed as a detachable connection, for example, as a threaded connection. This detachable connection is constructed, in particular, so that one-sided accessibility of the flange connection is sufficient for assembly. Thus, the flange connection permits final closing and/or sealing of the receiving section at the same time. The detachable connection permits a high degree of assembly and repair-friendly handling.

For the arrangement of the threaded connections, the flange section has, in particular, a plurality of passage openings running in the axial direction and spaced apart from each other in the circumferential direction and receiving openings running flush with the passage openings. The receiving openings are formed, for example, as pocket holes so that penetration of contaminating particles or moisture is prevented. The detachable connection permits, in particular, the exchange and/or reuse of individual components, e.g., of the flange section and/or of the part that can be connected or is connected to the flange section, in particular, the stabilization part. Another advantage is the accessibility to the receiving section by removing the flange section from the receiving section.

Optionally, the holding body extends in the radial direction beyond the passage of the threaded connections, wherein the holding body has passage openings running in the axial direction for the passage of the threaded connections and flush to the receiving openings. It is preferred, however, that the smallest end section projecting radially inward or the largest end section projecting radially outward of the holding body does not overlap the passage and receiving openings. A passage of threaded connections through the holding body for connecting the coupling body and the flange section is thus not necessary.

As an alternative to the detachable connection between the flange section and the coupling body, the connection is constructed as a non-detachable connection. For example, the non-detachable connection could be a rivet connection that is preferably passed through the passage openings and pressed and/or welded into the receiving openings. A clinched connection or other connection type based on a suitable shaping method is also possible. This connection, however, has the advantage that accessibility is ruled out and manipulation of assemblies in the receiving section from the side of the flange assembly is ruled out.

According to one possible construction of the invention, the flange section is arranged within the receiving section at least in some sections. In particular, the flange section has an end area that is held with an outer lateral surface with a positive fit by the inner lateral surface of the receiving section. Through the positive fit holding of the end area, on one hand, a centering for the arrangement of the flange section on the holding section is realized. Thus, a simplified assembly of the flange section on the receiving section is achieved. On the other hand, the end area forms an additional support function of the flange section on the receiving section for the application of a force, in particular, the application of a bending torque.

An advantageous implementation of the invention is characterized in that the flange section is connected to the receiving section with a positive fit in the circumferential direction. Advantageously, the facing axial contact end faces of the flange section and the receiving section have positive-fit geometries for a positive fit connection in the circumferential direction. Possible constructions for the positive-fit geometries are intermeshing teeth, for example, various tooth arrangements, Hirth coupling, or also notches, grooves, or similar connections. The anti-rotational locking, in particular, the positive fit connection in the circumferential direction, permits a direct transfer of torque from the flange section to the receiving section. In contrast, the axial flow of forces is led from the flange section via the axial connection, especially the threaded connection, rivet connection, clinched connection, or weld connection, to the coupling body and further via the holding body to the receiving section.

Alternatively or additionally, the outer lateral surface of the end area of the flange section and the adjacent inner lateral surface of the receiving section have positive-fit geometries for the anti-rotational locking for a positive fit in the circumferential direction. Possible constructions for the positive-fit geometries are intermeshing teeth, involute connections, knurled connections, aligning pins, or also notches, grooves, or similar connections. Thus, the radial flow of forces or the transfer of torque is led from the flange section to the receiving section via the positive fit directly to the receiving section.

Alternatively or additionally, the coupling body and the receiving section are connected to each other with a positive fit in the circumferential direction. In particular, the outer lateral surface of the coupling body and the adjacent inner lateral surface of the receiving section have positive-fit geometries for the anti-rotational locking for the positive fit in the circumferential direction. Possible constructions for the positive-fit geometries are intermeshing teeth, for example, various tooth arrangements, involute connections, knurled connections, aligning pins, or also notches, grooves, or similar connections.

Another object of the invention relates to a chassis actuator, in particular, a roll stabilizer in a motor vehicle with the flange assembly. In particular, the roll stabilizer enables an improvement of the roll stability of the motor vehicle. The chassis actuator, in particular, the roll stabilizer, comprises a stabilization part and an actuator connection part of an actuator. The stabilization part can be coupled with a wheel of the motor vehicle, for example, via a wheel suspension. The stabilization part is coupled with the actuator connection part. The actuator connection part comprises the receiving section, wherein the stabilization part has the flange section and wherein the stabilization part is coupled with the actuator connection part via the flange assembly. Advantageously, the stabilization part is connected integrally with the flange section. Alternatively, the stabilization part is connected to the flange section via a material-fit connection or via connection means, for example, threaded connections. In particular, the stabilization part has a tube section that is preferably arranged coaxial or eccentric or out-of-center relative to the flange section, wherein the flange section is preferably formed as a ring-shaped flange.

In one preferred structural implementation of the invention, the chassis actuator, in particular, the roll stabilizer, comprises the actuator, wherein the actuator has an actuator housing as the actuator connection part and an electric motor and wherein the electric motor is rotationally locked with the actuator housing. In particular, the receiving section forms a sub-section or end section of the actuator housing, so that the stabilization part is connected rotationally locked or rotationally rigid to the actuator housing via the flange assembly. The output of the electric motor is coupled with a transmission. The output of the transmission is coupled with another stabilization part. By activating the electric motor, a torsion pretensioning is realized between the stabilization part coupled with the actuator housing and the stabilization part coupled with the output of the transmission.

In principle, the assembly can be performed as follows: For the flange assembly, in a first step, a receiving section is prepared. In a second step, the coupling body is arranged on the receiving section. In particular, the coupling body is arranged within the receiving section. Here it is preferred that the coupling body is held with a positive fit in the radial direction by the receiving section. In a third step, the holding body is arranged on the receiving section, in particular, within the receiving section. Advantageously, the holding body is arranged, in particular, clipped, in an annular groove of the receiving section. In a fourth step, the flange section is arranged on the receiving section. In a fifth step, the flange section is connected to the coupling body, for example, by means of threaded connections. This assembly method shows the advantage that a one-sided accessibility of the receiving section is sufficient for assembly.

Another object of the invention relates to an alternative method for the assembly of the flange assembly according to the previous description. Here, a self-holding preassembly module is initially mounted from the flange section, the coupling body, and the holding body. This can be stored, e.g., until needed. The preassembly module is only inserted into the receiving section in a subsequent step, wherein in this step, the already mounted holding body is connected to the receiving section and then the flange section is clamped or swaged with the receiving section. Through this alternative method for assembly, a considerably simplified and secure final assembly of the flange assembly and/or the chassis actuator is achieved.

### BRIEF DESCRIPTION OF THE DRAWINGS

Additional features, advantages, and effects of the invention are given from the following description of preferred embodiments of the invention, as well as of the accompanying figures. Shown herein are:

FIG. 1 in a schematic diagram, a roll stabilizer with one actuator and two stabilization parts;

FIG. 2 in a two-dimensional diagram, a flange assembly as a first embodiment of the invention;

FIG. 3 in a two-dimensional diagram, the flange assembly as a second embodiment of the invention; and

FIG. 4 in a two-dimensional diagram, the flange assembly as a third embodiment of the invention.

### DETAILED DESCRIPTION OF THE PREFERRED EMBODIMENTS

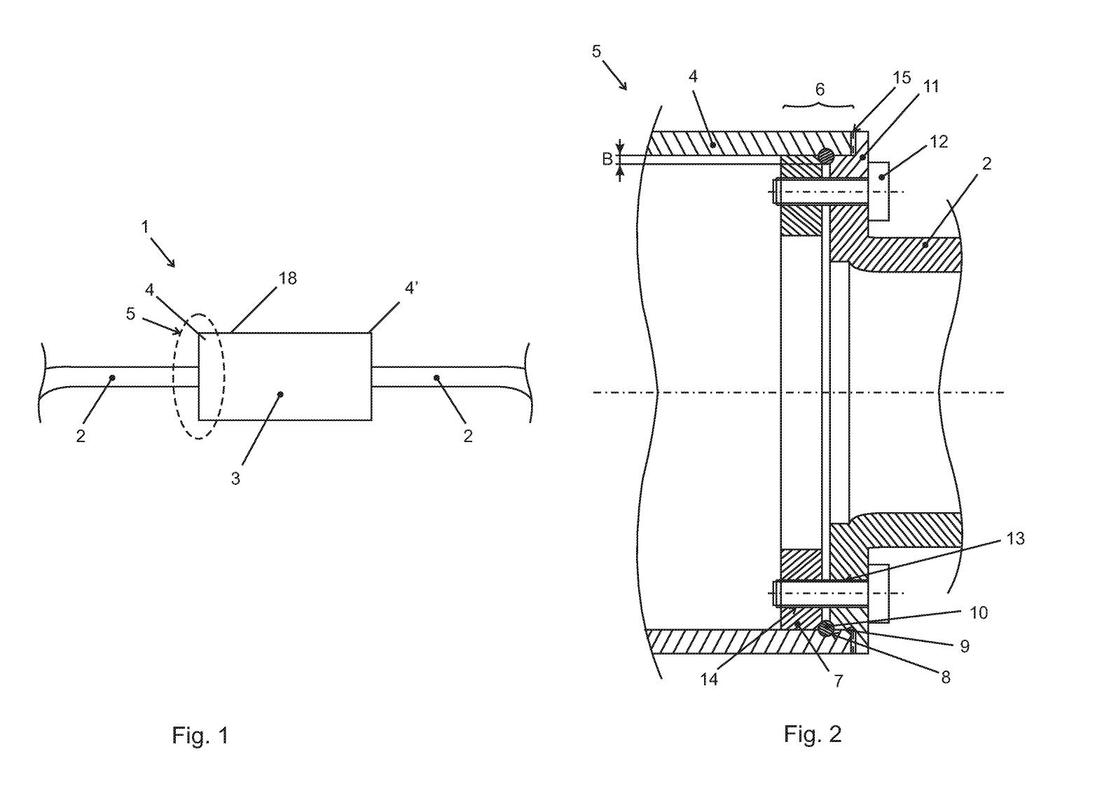

FIG. 1 shows a roll stabilizer 1 for a motor vehicle. The roll stabilizer 1 achieves, in particular, an improvement in the roll stability of the motor vehicle. The roll stabilizer 1 comprises a first and a second stabilization part 2, wherein here a sub-section of the two stabilization parts 2 is shown, as well as an actuator 3. The actuator 3 has an actuator connection part 4 (FIG. 2) and another actuator connection part 4′, wherein one of the stabilization parts 2 is coupled with the actuator connection part 4 via a flange assembly 5. The actuator connection part 4 is formed as a section of an actuator housing 18 and is connected rotationally locked to a not-shown electric motor in the actuator 3, in particular, with a stator of the electric motor. For example, the electric motor is arranged in the actuator housing 18 and is connected rotationally locked to this housing. The output side of the electric motor, in particular, the rotor of the electric motor, is coupled with a not-shown transmission that down converts the torque of the electric motor. The other actuator connection part 4′ is arranged on the output of the transmission. Optionally, between the output of the transmission and the other actuator connection part 4′ there can be a compensation module. Thus, the first stabilization part 2 is connected directly to the actuator housing 18 of the actuator 3 via the flange assembly 5 and the second stabilization part 2 is connected directly or indirectly to the output of the transmission of the actuator 15.

Through a controlled rotational movement, in particular, oscillation between the two actuator connection parts 4, 4′, a pretensioning of the stabilization parts 2 can be achieved by the electric motor, wherein a roll stabilization of the motor vehicle can be achieved.

FIG. 2 shows the flange assembly 5 sectioned in the axial direction as a first embodiment of the invention. By means of the flange assembly 5, one of the stabilization parts 2 is coupled with the actuator connection part 4. The actuator connection part 4 is formed as a part or end section of the sleeve-shaped actuator housing 18. The actuator connection part 4 and thus the actuator housing 18 comprises a receiving section 6, wherein the receiving section 6 is here formed as an end section, in particular, sleeve section of the actuator housing 18.

The flange assembly 5 comprises a coupling body 7 that is formed in this embodiment as a coupling ring. The actuator connection part 4, in particular, the receiving section 6, has an input opening through which the coupling body 7 was guided. The coupling body 7 is arranged inside the receiving section 6 and is held captively, in particular, with a positive fit, in the radial direction by the receiving section 6.

The receiving section 6 has an inner annular groove 8, wherein a snap-on edge 9 that has a smaller inner diameter than the inner annular groove 8 is formed by the inner annular groove 8. The snap-on edge 9 is arranged on the input opening of the actuator connection part 4, in particular, of the receiving section 6, or the snap-on edge 9 forms the input opening. The inner ring groove 8 has a circular cross section in the axial direction. Alternatively, a semicircular, oval, rectangular, or square cross section is possible.

In the inner annular groove 8, a holding body 10 is arranged. The holding body 10 is held captively in the inner annular groove 8. For example, the holding body 10 is formed as a radially flexible ring or as a retaining ring closed continuously in the circumferential direction. The holding body 10 extends radially inward and form an axial end stop for the coupling body 7 in an overlapping area B. Thus, the coupling body 7 is secured against removal or falling out in one of the axial directions, that is, in the direction of the holding body 10 and in the direction of the input opening.

The coupling body 7 has, in the overlapping area B, a complementary cutout, in this case, a quarter-circle-shaped cutout, so that a flat contact area is produced between the coupling body 7 and the holding body 10.

The stabilization part 2 comprises a flange section 11. The flange section 11 is formed here as an annular flange that is connected integrally to the stabilization part 2 and is arranged coaxial to the stabilization part 2. Through the ring-shaped construction of the flange section 11, it is possible to guide a cable from the actuator connection part 4 via the flange section 11 to the stabilization part 2. As an example alternative, the flange section 11 is formed as a disk-shaped flange. As another possible alternative, the flange section 11 has a ring-shaped tube section that is connected integrally, with a non-positive or material fit, to the stabilization part 2.

The flange section 11 and the coupling body 7 are connected to each other via threaded connections 12. For this, the flange section 11 comprises a plurality of passage openings 13 running the axial direction and spaced apart from each other in the circumferential direction and the coupling body 7 has receiving openings 14 running in the axial direction and aligned with the passage openings 13. The passage openings 13 and receiving openings 14 are formed as through holes. The receiving openings 14 can be alternatively formed as pocket holes.

By means of the threaded connections 12, the coupling body 7 is supported in the axial direction on the holding body 10 and the flange section 11 on the receiving section 6. In this way, the coupling body 7 and the flange section 11 are clamped or swaged to each other and the stabilization part 2 and the actuator connection part 4 are connected to each other. Facing axial contact end faces of the flange section 11 and the receiving section 6 are connected directly to each other for supporting the flange section 11 on the receiving section 6.

The facing contact end faces of the receiving section and of the flange section 6, 11 have positive-fit geometries 15 as positive fit contours in the circumferential direction, so that rotational locking is implemented between the flange section 11 and the actuator connection part 4. The positive-fit geometries 15 are, for example, intermeshing teeth.

The flange section 11 has an end area that is arranged within the receiving section 6. The end area is held with a positive fit in the radial direction by the inner lateral surface of the receiving section 6, in particular, by the inner lateral surface of the snap-on hook 9, by means of an outer lateral surface. Furthermore, the end area contacts the holding body 10 in the axial direction or is adjacent to the holding body. The end area has, in the overlapping area B, a cut-out that is complementary to the holding body 10, in this case, the quarter-circle-shaped cut-out, so that between the end area and the holding body 10 there is a flat contact area.

The flat contact areas of the end area of the flange section 11 and the coupling body 7 with the holding body 10 are formed such that the holding body 10 is pressed into the annular groove 8 by means of the force introduced by the clamping or swaging of the flange section 11 and the coupling body 7.

The coupling body 7 and the flange section 11 are arranged at a distance to each other in the axial direction. Thus, for the threaded connection of the coupling body 7 with the flange section 11, a planar contact of the flange section 11 on the receiving section 6 is guaranteed.

The flange section 11 completely closes the receiving opening of the actuator connection part 4, so that a reliable sealing of the actuator connection part 4 is achieved. Thus, the penetration of contaminating particles or moisture is prevented and consequently the functionality of electronic or electromechanical modules or parts in the actuator connection part 3 is guaranteed. Optionally, between the flange section 11 and the coupling body 7 and/or the holding body 10, an insert seal can be mounted in order to seal the flange assembly 5.

The flange assembly 5 forms a preassembled module for the actuator 3, wherein a considerably simplified and secure mounting of the actuator connection parts 4 with each other and the actuator 3 on the motor vehicle is produced. The parts of the flange assembly 5 according to the invention are connected to each other exclusively by means of detachable connections. Thus, the exchange and/or reuse of individual parts, e.g., the stabilization part 2, is possible. In addition, a removal of the flange section 11 is possible by detaching the threaded connections of the flange section 11 with the coupling body 7, which permits access to parts within the actuator connection part 4 or actuator 3.

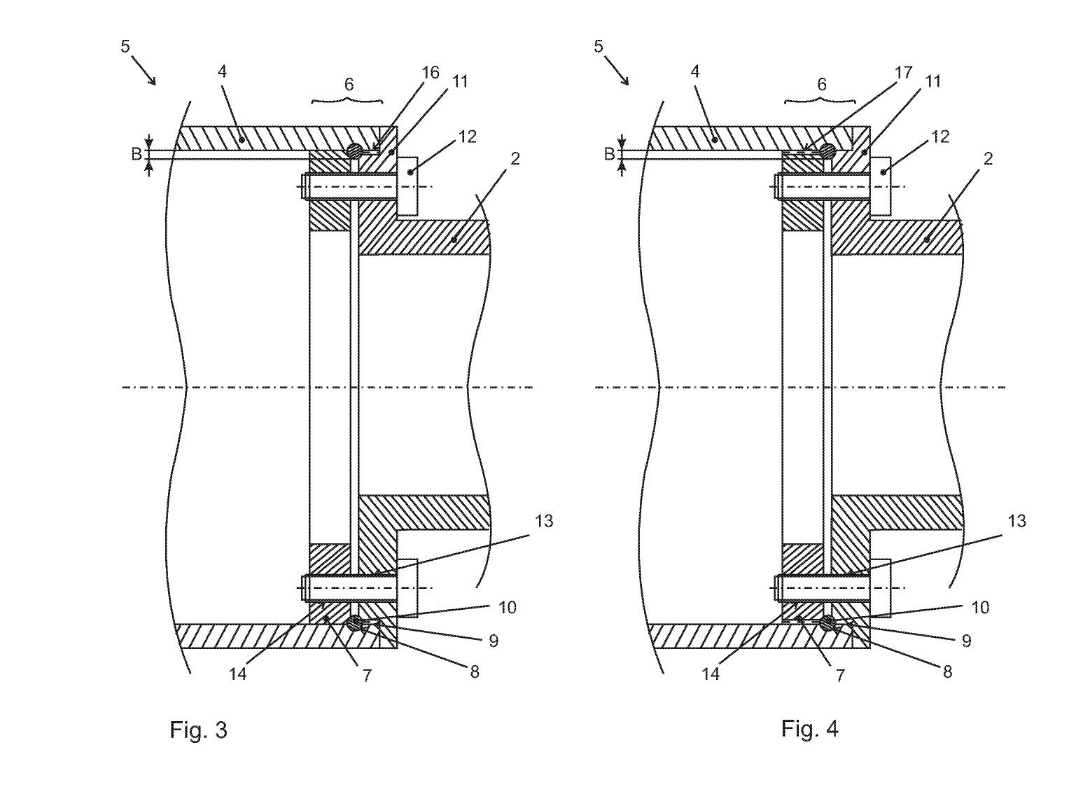

FIG. 3 shows the flange assembly 5 sectioned in the axial direction as a second embodiment of the invention. The flange assembly 5 comprises, as in the first embodiment, the receiving section 6 and the coupling body 7, which is arranged within the receiving section 6 and is held by the receiving section 6 in the radial direction and the holding body 10, which is arranged in the inner annular groove 8.

The stabilization part 2 comprises the flange section 11, wherein the flange section 11 is connected integrally with the stabilization part 2. In this embodiment, the stabilization part 2 is arranged eccentric to the flange section 11.

In this embodiment, the outer lateral surface of the end area of the flange section 11 and the contacting inner lateral surface of the receiving section 6 have positive-fit geometries 16 as positive fit contours for a positive fit in the circumferential direction. The positive-fit geometries 16 are, for example, intermeshing teeth. In this way, a rotational locking of the flange section 11, the stabilization part 2, and the coupling body 7 connected rigidly to the flange section 11 is implemented relative to the receiving section 6.

FIG. 4 shows the flange assembly 5 sectioned in the axial direction as a third embodiment of the invention. In this embodiment, the outer lateral surface of the coupling body 7 and the contacting inner lateral surface of the receiving section 6 have positive-fit geometries 17 as positive fit contours for a positive fit in the circumferential direction. The positive-fit geometries 17 are, for example, intermeshing teeth. In this way, rotational locking of the coupling body 7 and the flange section 11 connected rigidly to the coupling body 7 and the stabilization part 2 is implemented relative to the receiving section 6.

### LIST OF REFERENCE SYMBOLS

1 Roll stabilizer
2 Stabilization part
3 Actuator
4, 4′ Actuator connection part
5 Flange assembly
6 Receiving section
7 Coupling body
8 Inner annular groove
9 Snap-on edge
10 Holding body
11 Flange section
12 Threaded connection
13 Passage opening
14 Receiving opening
15 Positive-fit geometries of the axial contact end faces of the flange section and of the receiving section in the circumferential direction
16 Positive-fit geometries of the lateral surfaces of the end area of the flange section and of the receiving section in the circumferential direction
17 Positive-fit geometries of the lateral surfaces of the coupling body and of the receiving section in the circumferential direction
18 Actuator housing
B Overlapping area

1. A flange assembly comprising a flange section and a receiving section, the flange section is connected to the receiving section,
a holding body and a coupling body, the holding body is connected to the receiving section, wherein the holding body is arranged in an axial direction between the coupling body and the flange section, the coupling body is supported in the axial direction on the holding body, and the coupling body and the flange section are connected to each other and the flange section is connected to the receiving section through the support of the coupling body on the holding body.

2. The flange assembly according to claim 1, wherein at least one of the coupling body or the holding body are arranged within the receiving section.

3. The flange assembly according to claim 1, wherein the holding body is held with a positive fit in the axial direction in the receiving section.

4. The flange assembly according to claim 1, wherein the receiving section comprises an inner annular groove in which the holding body is arranged in a self-retaining manner.

5. The flange assembly according to claim 4, wherein the holding body is secured by at least one of the coupling body the flange section against slipping out from the inner annular groove.

6. The flange assembly according to claim 1, wherein the flange section is supported on the receiving section in the axial direction.

7. The flange assembly according to claim 1, wherein the flange section is arranged at a distance to the coupling body.

8. The flange assembly according to claim 1, wherein the coupling body and the flange section are connected by a threaded connection, rivet connection, or a clinched connection.

9. The flange assembly according to claim 1, wherein the flange section is connected to the receiving section with a positive fit in a circumferential direction.

10. The flange assembly according to claim 9, wherein facing axial contact end faces of the flange section and of the receiving section have positive-fit geometries for a positive fit in the circumferential direction.

11. The flange assembly according to claim 9, wherein an outer lateral surface of an end area of the flange section and a connecting inner lateral surface of the receiving section have positive-fit geometries for a positive fit in the circumferential direction.

12. The flange assembly according to claim 1, wherein the coupling body is connected to the receiving section with a positive fit in a circumferential direction.

13. A chassis actuator for arrangement in a motor vehicle comprising a flange assembly according to claim 1, a stabilization part and an actuator connection part, the actuator connection part comprises the receiving section and the stabilization part comprises the flange section and wherein the stabilization part is coupled to the actuator connection part via the flange arrangement.

14. The chassis actuator according to claim 13, wherein the actuator connection part is constructed as an actuator housing, the receiving section forms a sub-section or end section of the actuator housing and the stabilization part is rotationally locked with the actuator housing via the flange assembly.

15. A method for producing a flange assembly according to claim 1, comprising the following steps: mounting the flange section with the coupling body and the holding body as a self-holding preassembly module; and mounting the preassembly module in the receiving section.
